(19) United States
(12) Patent Application Publication
(10) Pub. No.: US 2016/0340590 A1
(43) Pub. Date: Nov. 24, 2016

(54) SYSTEM AND METHOD FOR PROCESSING NON-LIGNOCELLULOSIC WASTE

(71) Applicant: The Royal Institution for the Advancement of Learning / McGill University, Montréal (CA)

(72) Inventors: Vijaya Raghavan, Pincourt (CA); Shrikalaa Kannan, Sainte-Anne-de-Bellevue (CA); Yvan Gariepy, Sainte-Anne-de-Bellevue (CA)

(73) Assignee: The Royal Institution for the Advancement of Learning / McGill University, Montréal (CA)

(21) Appl. No.: 15/159,963

(22) Filed: May 20, 2016

Related U.S. Application Data
(60) Provisional application No. 62/165,292, filed on May 22, 2015.

(51) Int. Cl. C10B 53/00; C10B 19/00; C10B 57/08; C10L 5/42; C05D 9/00

(52) U.S. Cl. CPC C10B 53/00; C10L 5/42; C05D 9/00; C10B 57/08; C10B 19/00; C10L 2200/0469; C10L 2290/08; C10L 2290/26; C10L 2290/06; C10L 2290/36

(57) ABSTRACT

A method for processing non-lignocellulosic waste comprises pre-treating the non-lignocellulosic waste by enzymatic hydrolysis to yield a pre-treated non-lignocellulosic waste subjecting the pre-treated non-lignocellulosic waste to microwave hydrothermal carbonization to yield at least one of a hydrochar and a biocrude liquor. A system for processing non-lignocellulosic waste includes an enzymatic hydrolysis station for receiving non-lignocellulosic waste and generating a treated non-lignocellulosic waste, and a microwave hydrothermal carbonization station downstream of the enzymatic hydrolysis station for receiving the treated non-lignocellulosic waste from the enzymatic hydrolysis station and generating at least one of a hydrochar and a biocrude liquor.

### CROSS REFERENCES TO RELATED APPLICATIONS

This application claims the benefit of U.S. Provisional Patent Application No. 62/165,292, filed on May 22, 2015, which is incorporated herein by reference in its entirety.

### FIELD

This document relates to systems and methods for processing non-lignocellulosic waste. More specifically, this document relates to bio-fuel production from non-lignocellulosic waste, such as that arising from animal agriculture, agricultural animal processing, aquaculture, and aquatic animal processing.

### BACKGROUND

Kaushik et al. (2014) discloses subjecting food waste to enzymatic hydrolysis prior to hydrothermal treatment to produce hydrochars and bio-oil.

Afolabi et al. (2015) discloses the microwave hydrothermal carbonization of human biowastes.

### SUMMARY

The following summary is intended to introduce the reader to various aspects of the disclosure, but not to define or delimit any invention.

According to some aspects, a method for processing non-lignocellulosic waste includes: a) pre-treating the non-lignocellulosic waste by enzymatic hydrolysis to yield a pre-treated non-lignocellulosic waste; and b) subjecting the pre-treated non-lignocellulosic waste to microwave hydrothermal carbonization to yield at least one of a hydrochar and a biocrude liquor.

In some examples, the non-lignocellulosic waste is not combined with any lignocellulosic waste in steps a) and b).

The non-lignocellulosic waste can be or can include animal tissue. The non-lignocellulosic waste can be or can include aquatic animal tissue. The non-lignocellulosic waste can be or can include at least one of fish tissue and shellfish tissue. The shellfish tissue can be or can include crustacean tissue. The shellfish tissue can be or can include shrimp tissue and/or lobster tissue. The shellfish tissue can be or can include exoskeleton.

The method can further include: c) separating the hydrochar from the biocrude liquor; and d) drying the hydrochar.

Step b) can include subjecting the pre-treated non-lignocellulosic waste to microwave hydrothermal carbonization at a temperature of between 120 degrees Celsius and 250 degrees Celsius, or at a temperature of between 150 degrees Celsius and 210 degrees Celsius, or at a temperature of between about 150 degrees Celsius and 180 degrees Celsius.

Step b) can include subjecting the pre-treated non-lignocellulosic waste to microwave hydrothermal carbonization for a time of between 45 minutes and 180 minutes, or a time of between 60 minutes and 120 minutes, or a time of about 60 minutes.

The method can further include, prior to step a), homogenizing and cooking the non-lignocellulosic waste.

Step a) can include: pre-treating the non-lignocellulosic waste with at least one of a carbohydrase enzyme, an amylase enzyme, a lipase enzyme, a protease enzyme, an arabanase enzyme, a beta-glucanase enzyme, and a xylanase enzyme.

In step a), the enzyme concentration can be between 2.5 wt % and 50 wt %, or between 10 wt % and 20 wt %.

Step a) can include pre-treating the non-lignocellulosic waste by enzymatic hydrolysis for a period of between 1 hour and 60 hours, or for a period of between 4 hours and 24 hours, or for a period of about 16 hours.

The method can further include using the hydrochar as a fuel.

According to some aspects, a system for processing non-lignocellulosic waste includes: an enzymatic hydrolysis station for receiving non-lignocellulosic waste and generating a treated non-lignocellulosic waste; and a microwave hydrothermal carbonization station downstream of the enzymatic hydrolysis station for receiving the treated non-lignocellulosic waste from the enzymatic hydrolysis station and generating at least one of a hydrochar and a biocrude liquor.

The system can further include a preparation station upstream of the enzymatic hydrolysis station for homogenizing and/or cooking the non-lignocellulosic waste.

The system can further include a post-treatment station downstream of the microwave hydrothermal carbonization station for separating the hydrochar and the biocrude liquor. The separation of the hydrochar and the biocrude liquor can be by filtration.

### BRIEF DESCRIPTION OF THE DRAWINGS

The drawings included herewith are for illustrating various examples of articles, methods, and apparatuses of the present specification and are not intended to limit the scope of what is taught in any way. In the drawings:

FIG. 1 is a flow chart of an example method for processing non-lignocellulosic waste;

FIG. 2 is a schematic drawing of an example system for processing non-lignocellulosic waste;

FIG. 3A is a graph showing a line fit of actual and predicted glucose yield resulting from full-factorial screening (ANOVA) design of fish tissue waste;

FIG. 3B is a surface plot of amount of waste and treatment time resulting from full-factorial screening (ANOVA) design of fish tissue waste;

FIG. 3C is a surface plot of treatment time and enzyme concentration resulting from full-factorial screening (ANOVA) design of fish tissue waste;

FIG. 3D is a surface plot of amount of waste and enzyme concentration resulting from full-factorial screening (ANOVA) design of fish tissue waste;

FIG. 4A is a graph showing a line fit of actual and predicted glucose yield resulting from full-factorial screening (ANOVA) design of shrimp tissue waste;

FIG. 4B is a surface plot of amount of waste and treatment time resulting from full-factorial screening (ANOVA) design of shrimp tissue waste;

FIG. 4C is a surface plot of treatment time and enzyme concentration resulting from full-factorial screening (ANOVA) design of shrimp tissue waste;

FIG. 4D is a surface plot of amount of waste and enzyme concentration resulting from full-factorial screening (ANOVA) design of shrimp waste;

FIG. 5A is a graph showing trend lines for glucose yield (extent of hydrolysis) from fish tissue waste (FW) under varying enzyme concentrations (0, 2.5, 5, 10, 20, and 50% w/w) and varying treatment times (0-60 h);

FIG. 5B is a graph showing trend lines for glucose yield (extent of hydrolysis) from shrimp tissue waste (SW) under varying enzyme concentrations (0, 2.5, 5, 10, 20, and 50% w/w) and varying treatment times (0-60 h);

FIG. 6A is a graph showing trend lines for glucose yield (extent of hydrolysis) from fish tissue waste (FW) under varying enzyme cocktail ratio (V:P:L=1:1:1; 1:1:2; 1:2:1; and 2:1:1; V: Viscozyme; P: Protease; L: Lipase);

FIG. 6B is a graph showing trend lines for glucose yield (extent of hydrolysis) from shrimp tissue waste (SW) under varying enzyme cocktail ratio (V:P:L=1:1:1; 1:1:2; 1:2:1; and 2:1:1; V: Viscozyme; P: Protease; L: Lipase);

FIG. 7 is a bar-graph showing hydrochar yield from microwave hydrothermal carbonization of aquatic animal tissue waste;

FIG. 8 shows the FTIR spectra of fish tissue waste (A) and hydrochar produced from fish tissue waste (B)

FIG. 9 shows the FTIR spectra of shrimp tissue waste (A) and hydrochar produced from fish tissue waste (B);

FIG. 10 shows scanning electron microscope images of hydrochar produced from fish (left) and shrimp (right) tissue waste;

FIG. 11A is a photograph of hydrochar and biocrude oil produced from pre-treated fish (left) and shrimp (right) tissue waste; and

FIG. 11B is a photograph of dried hydrochar produced from fish tissue waste (left) and shrimp tissue waste (right) after 24 hours of oven drying.

### DETAILED DESCRIPTION

Various apparatuses or processes will be described below to provide an example of an embodiment of the claimed subject matter. No embodiment described below limits any claim and any claim may cover processes or apparatuses that differ from those described below. The claims are not limited to apparatuses or processes having all of the features of any one apparatus or process described below or to features common to multiple or all of the apparatuses described below. It is possible that an apparatus or process described below is not an embodiment of any exclusive right granted by issuance of this patent application. Any subject matter described below and for which an exclusive right is not granted by issuance of this patent application may be the subject matter of another protective instrument, for example, a continuing patent application, and the applicants, inventors or owners do not intend to abandon, disclaim or dedicate to the public any such subject matter by its disclosure in this document.

Disclosed herein are systems and methods for processing non-lignocellulosic waste, such as waste arising from animal agriculture, agricultural animal processing, aquaculture, and aquatic animal processing. The systems and methods may yield biofuels. Particularly, the systems and methods may yield hydrochar and/or biocrude liquor, either of which may be used directly as fuel or may be further processed into one or more fuels. In some examples, the systems and methods involve pre-treating non-lignocellulosic waste by enzymatic hydrolysis, and subjecting the pre-treated non-lignocellulosic waste to microwave hydrothermal carbonization to yield hydrochar and/or biocrude liquor.

As used herein, the term “non-lignocellulosic” refers to materials that are substantially free of cellulose and lignin. Non-lignocellulosic materials are typically materials that are not plant-based. The term “non-lignocellulosic” as used herein can refer to materials that are natural in origin, or materials that are the result of processing one or more raw materials and/or intermediate products, or materials that are byproducts, end-products or waste products. Non-limiting examples of non-lignocellulosic materials include animal tissues, more specifically non-aquatic animal tissues or aquatic animal tissues, more specifically fish tissue and shellfish tissue such as shrimp tissue. One non-limiting example of a non-lignocellulosic material that is a waste material (also referred to herein as “non-lignocellulosic waste) is fish or shellfish tissue waste from a fish processing plant. Additional examples of non-lignocellulosic materials include hydrochar and biocrude liquors made from animal tissues. On the other hand, as used herein, the term “lignocellulosic” refers to a substance that contains substantial amounts of both or one of cellulose and lignin. Lignocellulosic materials are typically plant based. For example, lignocellulosic materials can include or be formed from cell walls of plants.

As used herein, unless expressly stated otherwise, a “non-lignocellulosic material” or “non-lignocellulosic waste” can include one non-lignocellulosic material, or a combination of non-lignocellulosic materials.

Furthermore, unless expressly stated otherwise, the term “non-lignocellulosic material” or “non-lignocellulosic waste” refers to a material that includes only non-lignocellulosic material, and that is not combined with any lignocellulosic material.

As used herein, the term “fish tissue” can include but is not limited to endodermal tissue including digestive tract tissue, and/or respiratory tract tissue (including gills); mesodermal tissue including blood cells, cardiac and/or skeletal muscle tissue, and/or mineralized connective tissue including bone, teeth and/or scales; and/or ectodermal tissue including epidermal tissue, and/or central nervous system tissue.

As used herein, the terms “shellfish tissue”, “crustacean tissue”, and/or “shrimp tissue” can include, but are not limited to, endodermal tissue including digestive system tissue, and/or respiratory tract tissue (including gills); mesodermal tissue including haemolypmph, cardiac and/or skeletal muscle tissue, mineralized connective tissue including an exoskeleton; and/or ectodermal tissue including epidermal tissue, and nervous system tissue.

As used herein, the phrase “enzymatic hydrolysis” refers to the use of enzymes to break down complex biomolecules into monomers such as glucose. Enzymatic hydrolysis can facilitate subsequent polymerization of reactions during carbonization.

As used herein, the phrase “hydrothermal carbonization” refers to a process in which biomass is converted to carbonaceous material at a relatively low temperature (e.g. between 120 degrees Celsius and 250 degrees Celsius) and elevated pressure (i.e. elevated above the water saturation pressure) under wet conditions. The acronym “HTC” may also be used herein to refer to hydrothermal carbonization.

As used herein, the phrase “microwave hydrothermal carbonization” refers to HTC in which heating is effected by the use of microwaves (i.e. in which the heating is microwave dielectric heating). The acronym MHTC may also be used herein to refer to microwave hydrothermal carbonization.

As used herein, the term “hydrochar” refers to carbonaceous material that is coal-like, and that is the solid product of HTC or MHTC. Hydrochar can be used as a fuel. For example, hydrochar can be made into pellets and can be used as substitute for coal in gasifier and in coal power plants. Hydrochar can also, for example, be used for carbon sequestration of soil, can be activated to use as an adsorbent, or can be used in fuel cells to increase efficiency. Hydrochar can also, for example, be used as a fertilizer or a carbon sequestering agent.

As used herein, the term “biocrude liquor” refers to the liquid phase that is the product of HTC or MHTC. Biocrude liquor may include an aqueous phase and a non-aqueous phase. Biocrude liquor can be used, for example, as a fuel directly, or can be processed to biofuel. Biocrude liquor can also be used, for example, to extract organic substances such as hydroxymethyl furfural, which can then be used as fuel.

As mentioned above, the systems and methods described herein involve pre-treating non-lignocellulosic waste by enzymatic hydrolysis, and subjecting the pre-treated non-lignocellulosic waste to microwave hydrothermal carbonization to yield hydrochar and/or biocrude liquor. It has presently been determined that non-lignocellulosic waste, particularly waste from aquatic animal processing (e.g. fish tissue waste or shellfish tissue waste such as shrimp tissue waste), can be especially suitable for MHTC, due to its high moisture content. It is believed that the water molecules in the waste readily couple with electromagnetic fields and result in microwave dielectric heating. By using MHTC, relatively short residence times can be used, and thorough and controlled heating can be obtained.

Furthermore, it has presently been determined that MHTC of non-lignocellulosic waste, particularly waste from aquatic animal processing, in the absence of pretreatment by enzymatic hydrolysis, does not produce hydrochar. Furthermore, it has presently been determined that MHTC of aquatic animal tissue with pretreatment by acid or alkali does not produce hydrochar. However, pre-treatment of animal tissue by enzymatic hydrolysis followed by MHTC does result in hydrochar production. It is believed that enzymatic hydrolysis prior to MHTC of aquatic animal tissue is successful because the enzymes break down the complex molecules in the tissue, such as carbohydrates, proteins, and fats.

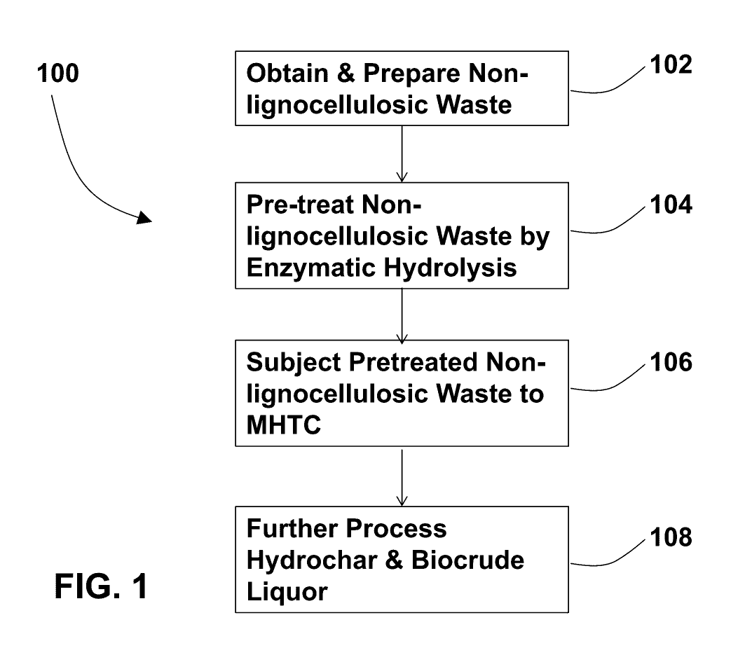

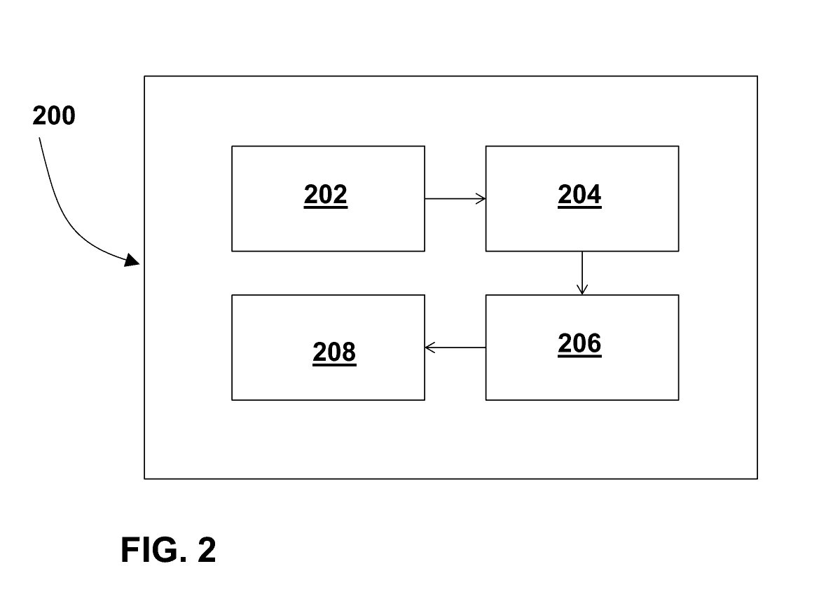

Referring now to FIGS. 1 and 2, a method 100 and system 200 for processing non-lignocellulosic waste are respectively shown. The method 100 will be described with reference to the system 200, and vice versa; however, the method may be carried out using other systems, and the system may be operated according to other methods.

Referring to FIG. 1, at step 102, the non-lignocellulosic waste may be obtained and prepared. For example, non-lignocellulosic waste may be obtained from an aquatic animal processing plant, such as a fish and/or shellfish processing plant, or a fish and/or shellfish waste processing plant, or from a fish market, or as left-over unsold material from retailers, either in fresh or frozen form. Various aquatic animal processing plants employ various processing methods depending on the raw material, and source of utility water. Filleting, freezing, drying, fermenting, canning and smoking are some of the common processes employed in the aquatic animal processing industry. After processing, fish and shellfish tissues such as but not limited to substandard muscles, viscera, heads, skins, fins, trimmings, and shellfish shells can be regarded as waste.

The non-lignocellulosic waste may be prepared, for example, by just homogenization or homogenization followed by cooking. The cooking may in some examples deactivate endogenous enzymes. Optionally, the waste may be frozen prior to, between, or after homogenization and cooking. Freezing the waste may reduce the rate of decomposition and the loss of volatile organics.

Referring to FIG. 2, step 102 may in some examples be carried out at a preparation station 202 of system 200.

Referring back to FIG. 1, at step 104, the non-lignocellulosic waste is pre-treated by enzymatic hydrolysis, to yield pre-treated non-lignocellulosic waste. The pre-treated non-lignocellulosic waste may include increased amounts of monomer sugars including glucose, as compared to the waste prior to pre-treatment.

The enzymatic hydrolysis (step 104) may be carried out with various enzymes, either alone or in combination (i.e. an enzyme “cocktail” may be used). Examples of enzymes that may be used include lipase enzymes, protease enzymes, carbohydrase enzymes, amylase enzymes, arabanase enzymes, beta-glucanase enzymes, and xylanase enzymes. Cellulase and hemicellulose enzymes may also be present.

In some particular examples, an enzyme cocktail of lipase, protease, and Viscozyme® may be used.

The enzymatic hydrolysis pre-treatment (step 104) may in some examples be carried out for a period of (or approximately of) 1 hour, 3 hours, 4 hours, 16 hours, 24 hours, 60 hours, between 1 hour and 60 hours, or between 4 hours and 24 hours.

The enzyme concentration during the pre-treatment step (step 104) may in some examples be (or be approximately) 2.5 wt %, 5 wt %, 10 wt %, 20 wt %, 50 wt %, between 2.5 and 50 wt %, or between 10 and 20 wt %.

The enzymatic hydrolysis pre-treatment (step 104) may in some examples be carried out at near neutral pH (e.g. pH 5 to pH 6), and at a temperature of between about 40 degrees Celsius and 50 degrees Celsius.

Referring to FIG. 2, the enzymatic hydrolysis (step 104) may be carried out at an enzymatic hydrolysis station 204 that receives the non-lignocellulosic waste and generates the pre-treated non-lignocellulosic waste. The enzymatic hydrolysis station 204 is downstream of the preparation station 102.

Referring back to FIG. 1, at step 106, the pre-treated non-lignocellulosic waste is subjected to microwave hydrothermal carbonization, to yield hydrochar and/or biocrude liquor.

The MHTC (step 106) can in some examples be carried out at a temperature of (or approximately of) 120 degrees Celsius, 150 degrees Celsius, 180 degrees Celsius, 210 degrees Celsius, 250 degrees Celsius, between 120 degrees Celsius and 250 degrees Celsius, or between 150 degrees Celsius and 180 degrees Celsius.

The pre-treated non-lignocellulosic waste can in some examples be subjected to MHTC for a time of (or approximately of) 45 minutes, 60 minutes, 120 minutes, 180 minutes, between 45 minutes and 180 minutes, or between 60 minutes and 120 minutes.

Referring to FIG. 2, the MHTC (step 106) can in some examples be carried out at a microwave hydrothermal carbonization station 206 (or MHTC station 206) that is downstream of the enzymatic hydrolysis station 204. The MHTC station can receive the treated non-lignocellulosic waste from the enzymatic hydrolysis station 204 and generate hydrochar and/or biocrude liquor.

Referring back to FIG. 1, at step 108, the hydrochar and biocrude liquor can be further processed. For example, the wet hydrochar can be separated from the biocrude liquor (e.g. by filtration such as vacuum filtration, or centrifugation), and dried (e.g. oven dried).

Referring to FIG. 2, step 108 can be carried out at a post-treatment station 208 downstream of the MHTC station 206.

The hydrochar and/or the biocrude liquor can then be used as fuel, or processed further.

### EXAMPLES

### Materials and Methods

Sample Preparation and Processing

Fish tissue waste including heads, tails, viscera, fins, and scales from a variety of fish including northern anchovy, salmon, and cod were obtained fresh from a local market. Likewise, tissue waste consisting of shell, head, and tail from shellfish varieties including pink shrimp, tiger shrimp and brown shrimp were obtained from a local market. Such a heterogeneous mixture of waste was taken so as to represent the heterogeneous waste produced from aquatic animal processing industries. The waste was stored at negative 20 degrees Celsius to reduce the rate of decomposition and loss of volatile organics until use. The required amount of waste was then weighed on the day of the experiment and homogenized with a food-grade blender.

Pretreatment by Enzymatic Hydrolysis

Enzymatic hydrolysis was carried out using three commercial enzymes: Viscozyme® (catalog no.: V2010), lipase (catalog no.: L0777), and protease (catalog no.: P4860) (Sigma-Aldrich).

Viscozyme® (V) is a multienzyme complex containing a wide range of carbohydrases including arabanase, cellulase, beta-glucanase, hemicellulase, and xylanase, with an enzyme activity of 100 FBGU/G; protease (P) was from Bacillus licheniformis, Subtilisin A, with an enzyme activity of 2.4 U/g; and recombinant lipase (L) was from Thermomyces lanuginosus, with an enzyme activity of 100 kU/g. One Fungal Beta-Glucanase Unit (FBGU) is the enzyme quantity which hydrolyzes fungal beta-glucan to reducing sugars corresponding to 1 μmol glucose per minute at pH 5.0 at 30 degrees Celsius. One protease unit is the enzyme quantity which hydrolyzes casein to produce 1.0 μmole of tyrosine per minute at pH 7.5 at 37 degrees Celsius. One lipase unit is defined as the enzyme amount which hydrolyzes 1.0 μmol of fatty acid per minute from a triglyceride at pH 7.7 at 37 degrees Celsius.

Preliminary studies were conducted in order to screen for factors that govern the hydrolysis of aquatic animal tissue waste. A full-factorial study was designed with three levels for each factor such as amount of waste (1, 2, and 3 g), enzyme concentration (5, 10, and 20% w/w), and treatment time (1, 2, and 3 h). The amount of waste was chosen as one of the factors to determine the effect of substrate concentration on the enzymatic hydrolysis of waste. Samples were taken in a 15 mL tube, to which the desired concentration of enzymes were added and incubated for appropriate time periods. The rate-limiting factors of the enzymatic hydrolysis, as determined from screening experiments, were then optimized to maximize the extent of hydrolysis. Conducting a screening study prior to optimization focused the efforts of optimization experiments on factors that significantly affected the hydrolysis of seafood waste.

Enzyme concentration (0-50 wt %) and treatment time (0-60 hours) were further optimized for obtaining maximum degree of hydrolysis. An enzyme ratio of 1:1:1 (V:P:L) was used for optimization experiments.

To test for any potential effect of varying enzyme ratios, four different enzyme mixture ratios (w/w/w) were applied to the waste: 1:1:1, 2:1:1, 1:2:1, and 1:1:2 (V:P:L; w/w/w) to establish the optimum enzyme mixture ratio. The incubation was performed in a laboratory incubator/shaker at approximately 40 degrees Celsius with rotation at 120 rpm. The extent of hydrolysis of the waste samples was assessed by determining the glucose concentration using Glucose Oxidase (GO) Assay kit (catalog no.: GAGO20; Sigma-Aldrich, Missouri, U.S.A.) as per the manufacturer's protocol and yield was calculated according to the following equation:

glucose yield (% w/w)=amount of glucose/amount of waste×100

Microwave Hydrothermal Carbonization

MHTC was conducted using the Mini WAVE Digestion Module (SCP Science, Canada) that operates at a frequency of 2.45 GHz. The pretreated waste was divided into 6 replicates and heated in cylindrical quartz reactor vessels. The sample temperatures were monitored with the help of IR sensors located on the sidewalls using a single magnetron that was located at the bottom of the treatment chamber. MHTC experiments were conducted at a holding temperature of 150 degrees Celsius for a holding time of 1 h. Once the reaction was completed, the reactor vessels were cooled to room temperature gradually by the integrated cooling unit of the microwave system. The product of MHTC process was then subjected to vacuum filtration to separate the solid fraction (i.e., wet hydrochar and biocrude liquor). The wet hydrochar was oven-dried at 105 degrees Celsius for 24 h to produce dry char, and the yield was calculated on a dry basis, as follows (where HC refers to hydrochar, EH refers to enzymatic hydrolysis, and W refers to waste):

yield of HC(%)=mass of HC (dry basis)/mass of W before EH (dry basis)×100

The yield of biocrude liquor was calculated as follows (where BL refers to biocrude liquor, W refers to waste, and EH refers to enzymatic hydrolysis):

yield of BL(%)=volume of BL after MHTC/volume of W after EH×100

Scanning Electron Microscope (SEM)

The raw samples and hydrochars recovered were analyzed and compared for their surface morphology and microstructure by a Hitachi TM-3000 (Tokyo, Japan) scanning electron microscope. Magnification from 50× to 2000× were used to analyze the structure.

Fourier Transform Infrared Spectroscopy (FTIR)

The FTIR technique was used to assay for the functional groups on the surface of the hydrochar produced from fish tissue waste and shrimp tissue waste. The diffuse reflectance spectra of the hydrochar samples were recorded by the FTIR spectrophotometer under dry nitrogen atmosphere (Nicolet Magna 158 750 FTIR, Nicolet Instrument Corp., Madison, Wis.) equipped with a liquid nitrogen-cooled mercury-cadmium-telluride detector and the OMNIC software (Thermo Nicolet Co., Madison, Wis.) was used for data collection and analysis. Several 50-scan spectra resolution of 2 cm⁻¹ were collected in the mid-infrared region (4000-600 cm⁻¹). A background spectrum of dry nitrogen atmosphere without the sample was recorded under the same instrumental conditions and subtracted from each sample spectrum.

Data Analysis

The data reported is mean±SE (standard error of the mean) unless otherwise indicated. Data analysis and statistics were conducted using JMP software (SAS Institute Inc., NC, U.S.A.) licensed to McGill University.

Results and Discussion

Screening of Process Factors that Govern Enzymatic Hydrolysis

Fish tissue waste and shrimp tissue waste were pretreated by enzymatic hydrolysis with an enzyme cocktail containing Viscozyme, lipase, and protease. Glucose yield is used as an indicator to determine the extent of hydrolysis.

Full-Factorial Screening of Enzymatic Hydrolysis Pre-Treatment of Fish Tissue Waste

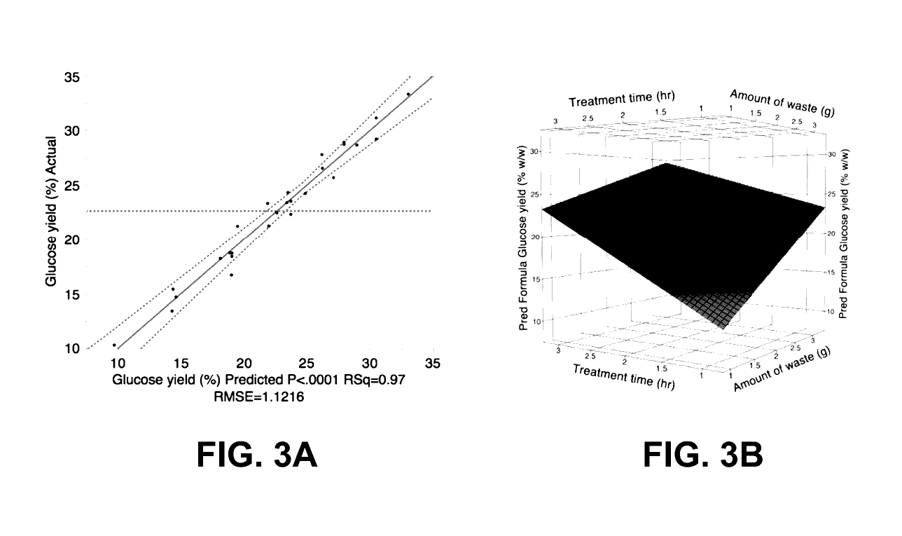

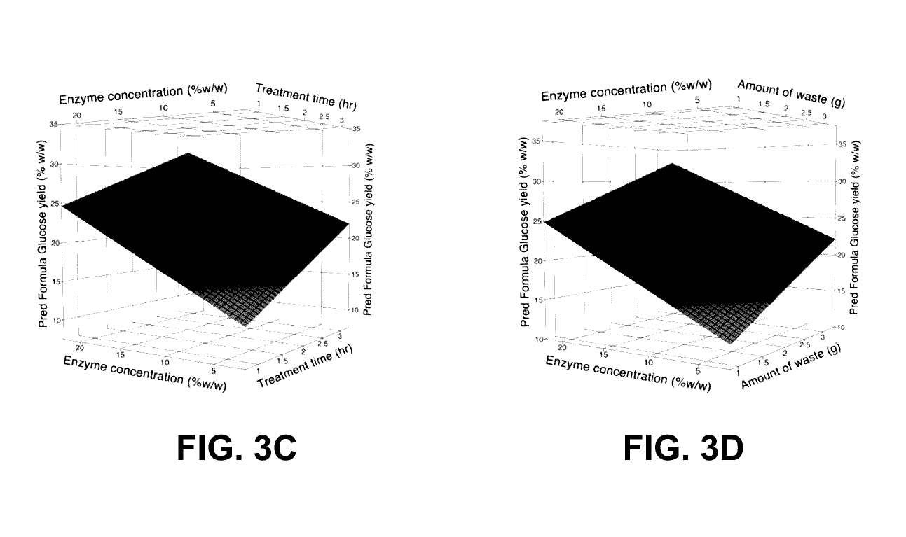

A full-factorial screening design was employed as described in the Materials and Methods section, with glucose yield (% w/w) as the dependent variable and amount of waste (g), treatment time (hr), and enzyme concentration (% w/w) as process parameters. The predictive model obtained with JMP showed good agreement between that the actual and predicted glucose yield values with an R² of 0.97 (FIG. 3A). This shows that the model can be used to predict the optimal values according to the process parameters. Surface plots of the dependence of glucose yield on the three-independent variables are shown in FIGS. 3B, 3C and 3D.

For fish tissue waste, the amount of waste (F_{1,17}=171.2422; p<0.0001), enzyme concentration (F_{1,17}=135.4856; p<0.0001), and treatment time (F_{1,17}=175.2144; p<0.0001) significantly affected the extent of enzymatic hydrolysis. As the treatment time increased from 1 to 3 h, glucose yield increased from 9.8 to 23.6%. Glucose yield also increased from 10.5 to 23.4% when the amount of waste increased from 1 to 3 g. When the enzyme concentration was used as an independent variable, glucose yield increased from 10.2 to 24.9%. Thus, each factor contributed significantly to the increase in glucose yield due to enzymatic hydrolysis of fish tissue waste.

Full-Factorial Screening of Enzymatic Hydrolysis Pretreatment of Shrimp Tissue Waste

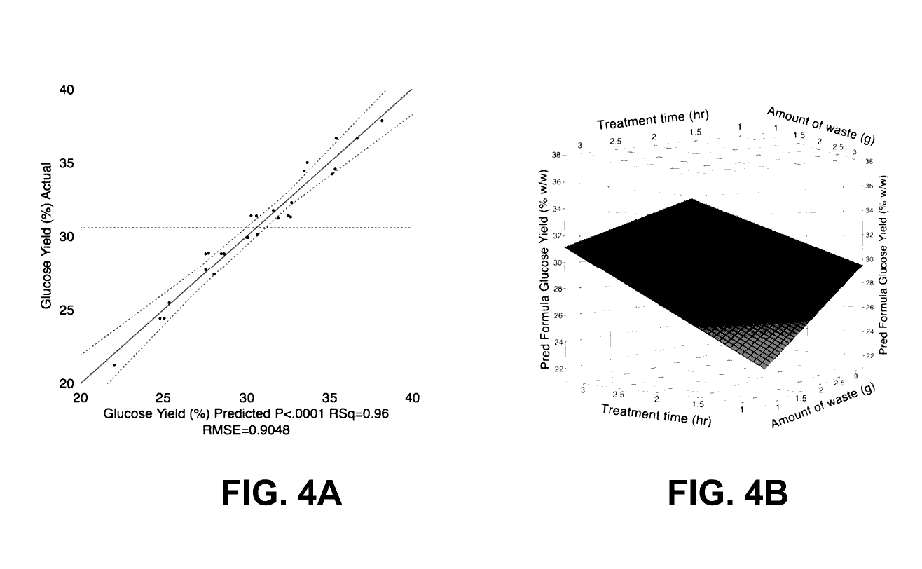

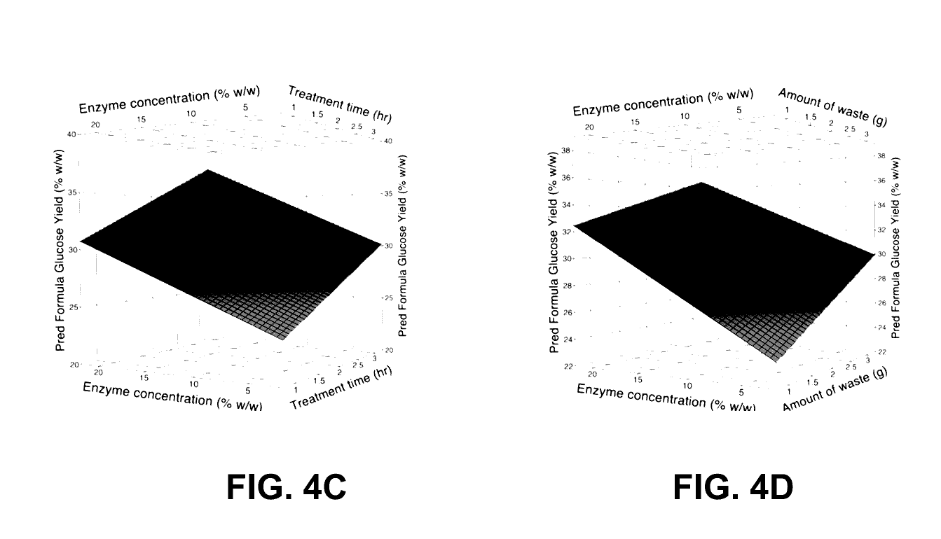

A similar full-factorial screening design as described for fish tissue waste was employed for shrimp tissue waste trials. The predictive model obtained from JMP showed that actual and predicted glucose yield correlated well with an R² of 0.96 (FIG. 4A). This confirms the reliability of the model to predict glucose yield according to the process parameters. The effects of varying the three independent variables on glucose yield are shown in FIGS. 4B-D. For shrimp tissue waste, the amount of waste (F_{1,17}=94.8808; p<0.0001), enzyme concentration (F_{1,17}=99.4557; p<0.0001) and treatment time (F_{1,17}=174.6585; p<0.0001) significantly affected the hydrolysis of shrimp waste. As the treatment time increased from 1 to 3 h, glucose yield also increased from 22.1 to 29.5%. Glucose yield increased from 22.3 to 32.5% when the amount of waste was increased. The glucose yield increased from 22.3 to 32.5% when the enzyme concentration increased from 5 to 20%. These results indicate that all three independent variables significantly determine the final glucose yield. When scaling up is done, all three factors (enzyme concentration, treatment time, and amount of waste used) may be used in determining the extent of hydrolysis of tissue waste.

Considering the fact that the amount of waste available is often constant (i.e., a certain quantity is available at that particular point in time), one can vary treatment time and hydrolysis enzyme concentration to maximize the hydrolysis irrespective of the type of tissue waste. The treatment time and enzyme concentration can be varied to maximize the yield of hydrochar, potentially with minimal effect on the economy of the process.

When heated at a temperature of 180 degrees Celcius for 2.5 h, aquatic animal tissue waste without enzymatic pretreatment failed to produce hydrochar. Without pretreatment, the waste is heated as a complex mixture of macromolecules that are not successfully broken down into simpler moieties yielding poor carbonization efficiency.

As acid and alkali pretreatment are cheaper alternatives to enzymatic pretreatment, their suitability was evaluated in carbonizing aquatic animal waste such as fish tissue waste and shrimp tissue waste. It was found that such waste treated with an acid (HCl; pH 3-5; 1-3 days) or alkali (NaOH; pH 9-12; 1-3 days) failed to produce hydrochar after MHTC (data not shown). This could be attributed to the poor digestibility of aquatic animal waste in an acid or alkali environment. On the other hand, enzyme hydrolysis pretreatment resulted in the successful production of hydrochar with reproducibility when held at a temperature of 150 degrees Celsius for 1 h during MHTC. The complex textural and structural organization of the macromolecules in aquatic animal tissue waste was not well hydrolyzed by acid or alkali.

Optimization of Enzyme Concentration and Treatment Time for Enzymatic Pretreatment.

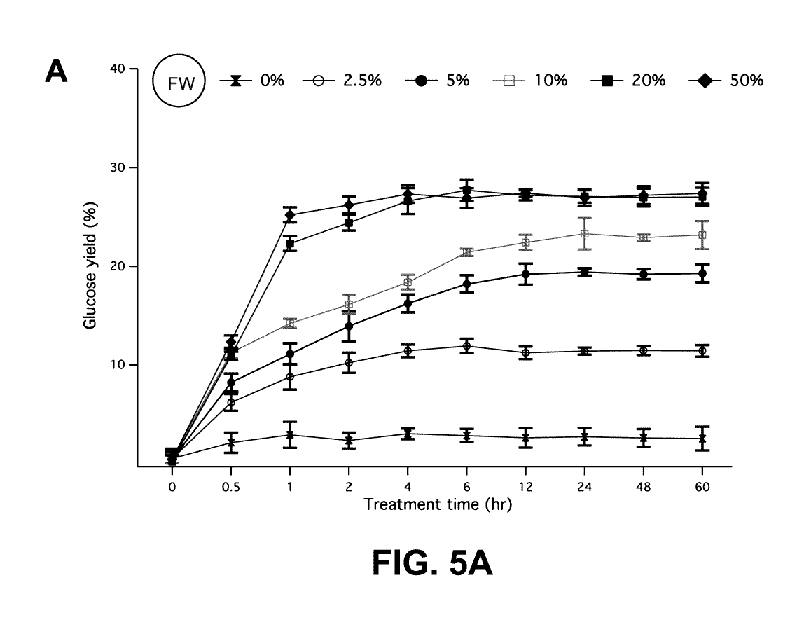

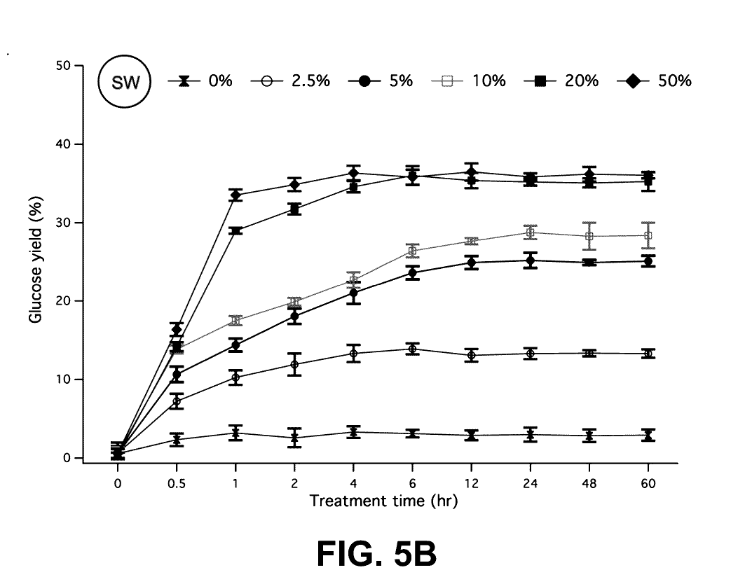

In order to optimize the hydrolysis process, the enzymatic pretreatment was carried out at increasing enzyme concentrations (0, 2.5, 5, 10, 20, and 50% w/w) while keeping the amount of waste constant at 1 g. The extent of hydrolysis was measured from 0 to 60 h. The effects of enzyme concentrations and pretreatment time on glucose concentrations are shown in FIGS. 5A (fish tissue waste) and 5B (shrimp tissue waste). The glucose yield increased as the enzyme concentration increased. From the overall trend of the hydrolysis of aquatic animal waste, glucose yield followed a similar trend; that is, the yield increased in both shrimp and fish tissue waste as the enzyme concentration and treatment time increased. At an enzyme concentration of 2.5% w/w, the glucose concentration was 5.2% in the shrimp waste and 4.2% in the fish tissue waste. At an enzyme concentration of 50% w/w, glucose yield reached 36% in shrimp tissue waste and 27% in the fish tissue waste. It was also observed that increasing the enzyme concentration from 20% to 50% w/w, did not result in increase in the extent of hydrolysis as measured from the glucose yield. On the other hand, increasing enzyme concentration from 10% to 20% w/w, resulted in a significant increase in the glucose yield. This showed that an enzyme concentration between 10 and 20% w/w could mark the range with which one could achieve an optimum level of hydrolysis. The glucose yield increased with increased treatment time. At high enzyme concentrations, glucose yield reached a plateau after 4 h of treatment. At high enzyme concentrations, the hydrolysis was complete as enzyme was available in surplus and the substrate was depleted the rate-limiting factor. For intermediate enzyme concentrations (2.5, 5, 10% w/w), the glucose yield reached a maximum at about 24 h, suggesting that enzyme concentration was still rate limiting. These results suggest that upon increasing the enzyme concentration or time, one could achieve higher glucose yields. However, at lower and intermediate enzyme concentrations, the hydrolysis will not be complete, as the glucose yield saturated after 4 and 24 h, respectively.

Effect of Enzyme Ratio on Aquatic Animal Waste Hydrolysis

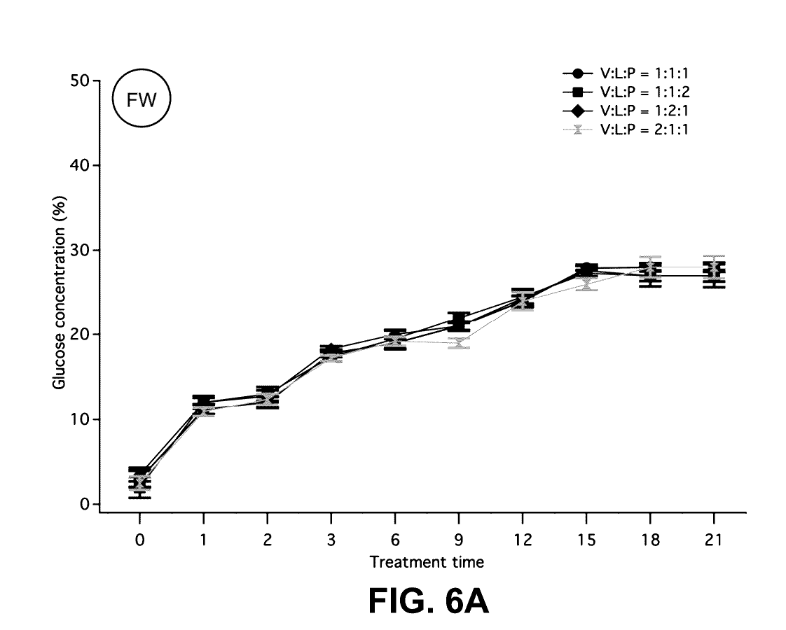

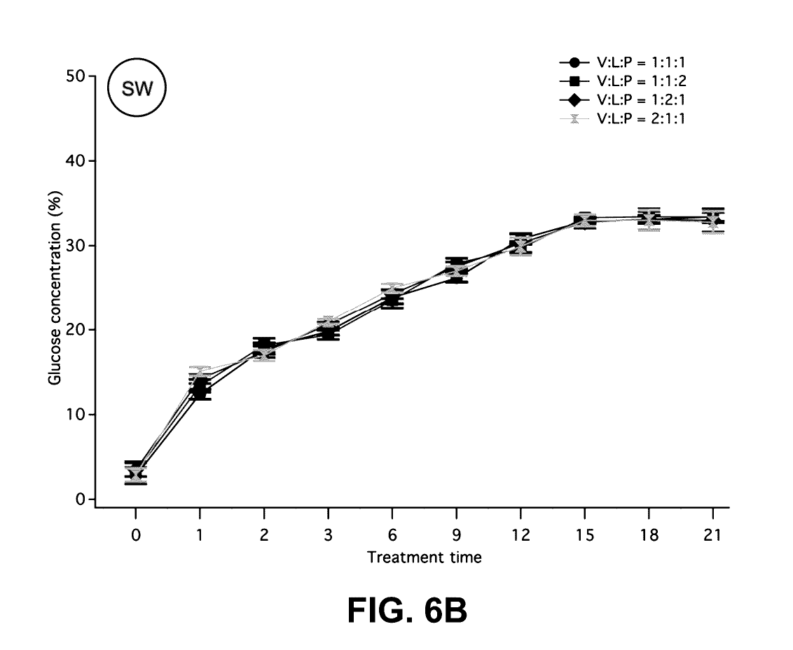

In order to assess the effect of enzyme ratio of the cocktail, different ratios of V, P, and L (1:1:1, 2:1:1, 1:2:1, and 1:1:2) were used to evaluate the extent of hydrolysis. As shown in FIGS. 6A (fish tissue waste) and 6B (shrimp tissue waste), glucose concentrations at the end of the hydrolysis process were similar for all enzyme cocktail ratio used. Therefore, enzyme cocktail ratio had little or no effects on the extent of hydrolysis of the fish tissue waste and shrimp tissue waste. An enzyme cocktail ratio of 1:1:1 (V:P:L) would minimize the amount of enzyme used and it appears best-suited enzymatic hydrolysis of fish and shrimp tissue waste.

Microwave Hydrothermal Carbonization (MHTC) of Aquatic Animal Tissue Waste

MHTC trials were conducted with 20 to 30 g of shrimp tissue waste and fish tissue waste. A MINIWAVE™ microwave digester was used to apply the microwave treatment. MHTC was performed after the enzyme pretreatment which consisted of 20% w/w enzyme concentration and a pretreatment duration of 16 h. MHTC process was carried out at 150 degrees Celsius for 1 h.

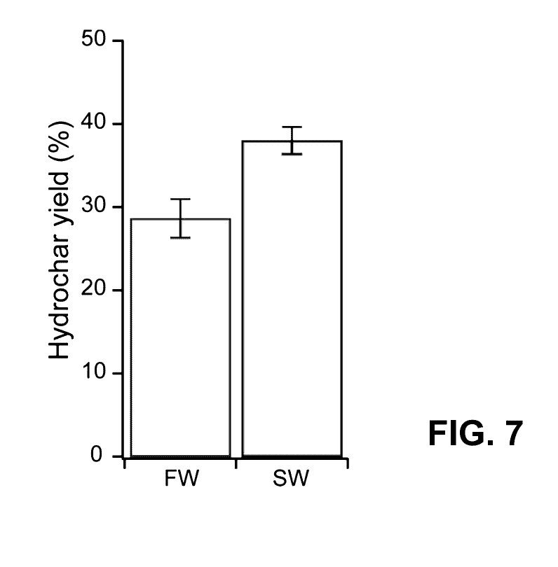

MHTC processing of both fish tissue waste and shrimp tissue waste resulted in the production of hydrochar with a coffee-like odor (FIG. 7). The hydrochar was mixed with the remaining liquid (biocrude liquor) The biocrude liquor was dark brown in color with a neutral pH of 7.0. The solid hydrochar was vacuum filtered from the biocrude liquor and oven-dried overnight. The mean yield of hydrochar from fish tissue waste was 28.67±2.32% dry weight (n=3) and 38.12±1.63% dry weight (n=3) from shrimp tissue waste. Biocrude liquor yields were 69.87±2.14% of total liquid for fish tissue waste and 77.14±1.31% total liquid for shrimp tissue waste. MHTC treatments were conducted at 150 degrees Celsius for 1 h. These conditions are at the lower end of the standard hydrochar generation temperature and holding time. The yield of hydrochar and biocrude liquor can be increased by increasing the MHTC treatment temperature to greater than 150 degrees Celsius (e.g. 180 and 210 degrees Celsius) and time to greater than 60 min (e.g. 120 and 180 min).

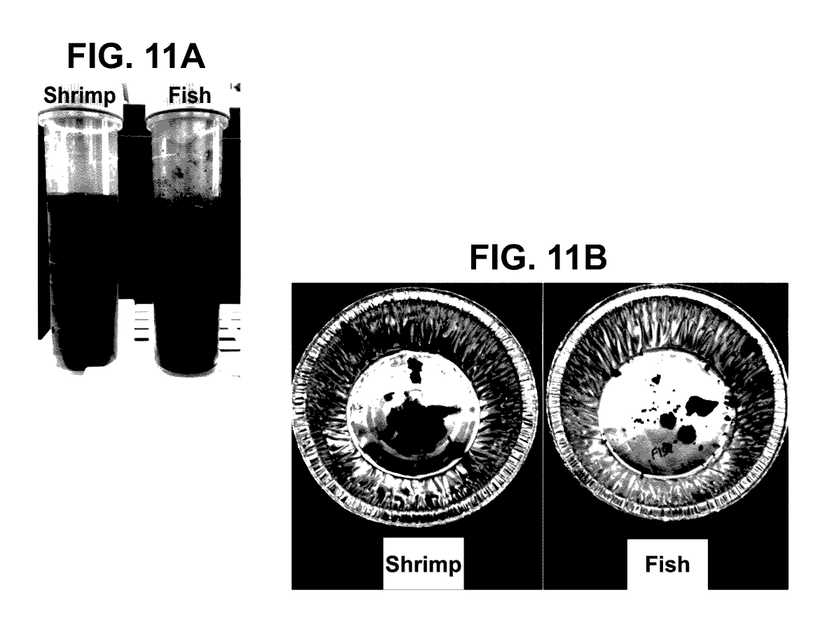

The products (i.e., hydrochar and biocrude liquor mixture) resulting from the MHTC treatment were characterized. As shown in Table 1, and in FIGS. 11A and 11B., the products produced were darker in color with a smell resembling that of ground coffee. As another benefit of the process it helped in the elimination of the foul odor associated with decomposing raw aquatic animal tissue waste. The darkening of the color suggests that the Maillard reaction might have occurred, resulting in the production of aromatic compounds and melanoidins.

TABLE 1
Physical Characteristics of Hydrochar Obtained after MHTC

| | | Physical Characteristics | | |
|---|---|---|---|---|
| Type of Material | | Color | Smell | Appearance |
| Fish | Raw | Gray | Putrid | Mixture of tissue, |
| Waste | | | | scales and head |
| | Hydrochar | Black | Ground | Powdery and crumbly |
| | | | coffee | |
| Shrimp | Raw | Light pink/ | Putrid | Mixture of tissue, head, |
| waste | | light orange | | hard exoskeleton |
| | Hydrochar | Black | Ground | Flaky, hard, flat |
| | | | coffee | |

FTIR Characterization of Hydrochar.

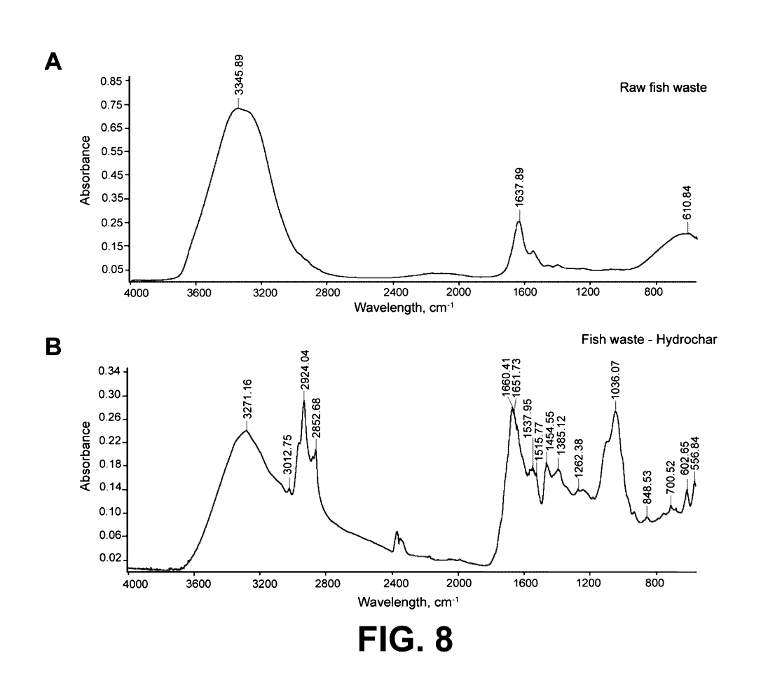

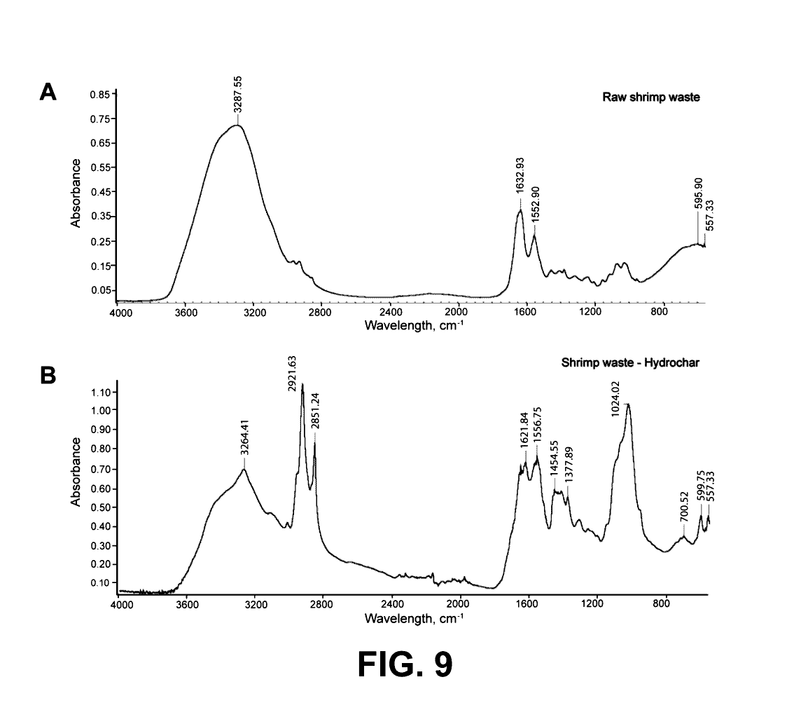

In order to understand the surface properties of hydrochar, FTIR analysis of hydrochar produced from fish tissue waste and shrimp tissue waste were carried out (FIGS. 8 and 9). The specific band assignments and corresponding references are shown in Table 2. The peaks at 3264 cm-1 were associated with organic O—H axial deformation, with bound water that may have been retained in the samples. The peaks at 2920-2850 cm⁻¹ were attributed to the presence of aliphatic structures like methylene axial deformation, ether or acid groups formed during MHTC. The peaks observed at 2924-2920 cm⁻¹ were attributed to symmetric C—H axial deformation. The peaks observed at 2853-2850 cm⁻¹ were assigned to symmetric C—H axial deformation. The presence of aromatic structures was demonstrated by the bands at 1454 cm⁻¹, which were attributed to C═C—C vibrations, and the bands in the 1000-1040 cm⁻¹ and 840-880 cm⁻¹ region were assigned to aromatic C—H in-plane and out-of-plane angular deformation vibrations, respectively. This indicated that polymerization and aromatization reactions occurred during MHTC. The coffee aroma exhibited by the hydrochar and biocrude liquor after MHTC further confirmed aromatization reactions. In the shrimp tissue waste hydrochar, the peak at 1621 cm⁻¹ and a medium intensity sawtooth shaped peak at 1556 cm⁻¹ were indicative of the characteristic primary and secondary amine N—H angular deformations found in chitosan and appeared to have remained intact during the carbonization process. The peak at 1262 cm⁻¹ noticed in the fish tissue waste hydrochar was indicative of the aromatic primary amine C—N axial deformation and suggested the occurrence of new cross-linking reactions during the carbonization process. The peaks at 1036 and 1024 cm⁻¹ represented C—H in plane angular deformation in aromatic groups. Comparative assessment of the FTIR spectra of raw tissue waste and hydrochar after MHTC, confirmed that aquatic animal tissue waste underwent several transformations during MHTC to produce hydrochar.

TABLE 2
Main functional groups assignment for the FTIR spectra of fish tissue
waste and shrimp tissue waste and hydrochar. The FTIR spectra peaks obtained
from fish tissue waste and shrimp tissue waste are indicated by FW and SW
respectively. R indicates an alkyl (—CH₂) group.

| Fish Waste | Shrimp Waste | | |
|---|---|---|---|
| Wavenumber | Wavenumber | | |
| (Cm⁻¹) | (Cm⁻¹) | Type Of Bond And Vibrations | References |
| 3345.89 (FW) | 3287.55 | O—H axial deformation in H₂O | Chen et al., 2008 |
| 3271.16 | 3264.41 | | Coates 2000 |
| 3012.75 | | sp2-hybridized C—H axial | Coates 2000 |
| | | deformation in CH₂═CH—R | |
| 2924.04 | 2921.63 | asymmetric C—H axial | Coates 2000 |
| | | deformation in CH₂ | |
| 2852.68 | 2851.24 | symmetric C—H axial deformation | Coates 2000 |
| | | in CH₂ | |
| 1660.41 | 1632.93 (SW) | C═C axial deformation in | Smidt and Meissl., |
| | | CH₂═CH—R | 2007 |
| 1651.73 | 1621.84 | N—H angular deformation in | Coates 2000 |
| | | NH₂—R (primary amine) | |
| 1637.89 (FW) | | | |
| 1537.95 | 1552.90 (SW) | N—H angular deformation on | Allison et al., 2009 |
| | | NH—RR′ (secondary amine) | |
| 1515.77 | 1556.75 | | Coates 2000 |
| 1454.55 | 1454.55 | C═C—C axial deformation in | Pavia et al., 1979 |
| | | C₆H₅—R (aromatic) | |
| | | | Coates 2000 |
| 1385.12 | 1377.89 | gem-dimethyl | Coates 2000 |
| 1262.38 | | C—N axial deformation in | El ichi et al., 2014 |
| | | RR′NCHO (tertiary amide) | |
| 1036.07 | 1024.02 | C—H in plane angular | Chen et al., 2008 |
| | | deformation in C₆H₅—R (aromatic) | |
| | | | Coates 2000 |
| 848.53 | | C—H out of plane angular | Kloss et al., 2012 |
| | | deformation in C₆H₅—R (aromatic) | |
| | | | Soldi et al., 2009 |
| 700.52 | 700.52 | O—H angular deformation in | Coates 2000 |
| | | R—OH (alcohol) | |
| 610.84 (FW) | 599.75 | S—S axial deformation in | |
| | | disulfides | |
| 602.65 | 595.50 (SW) | C—S axial deformation in | |
| | | disulfides | |
| 556.84 | 557.33 (SW and | C—H angular deformation in | |
| | hydrochar) | CH═CH | |

Scanning Electron Microscopy (SEM) Characterization of Hydrochar.

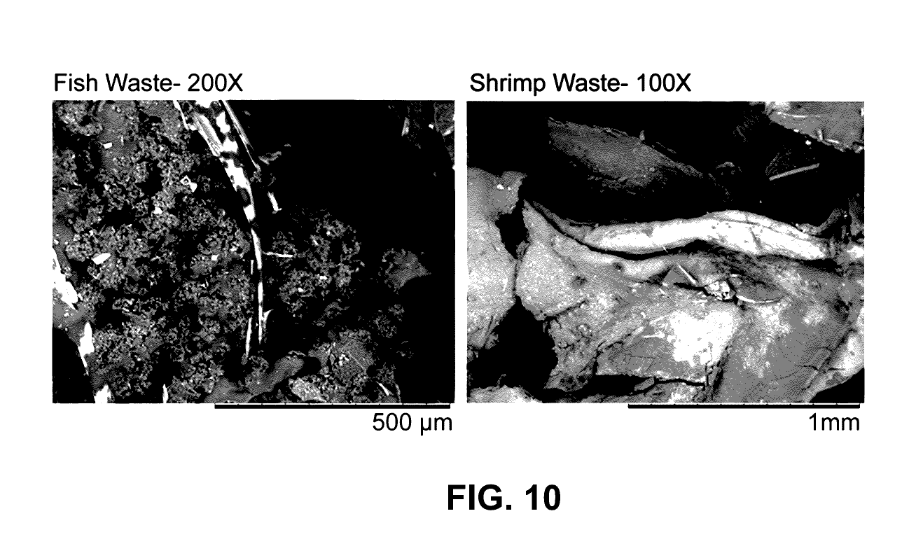

SEM micrographs enabled the analysis of microstructure of hydrochar produced from fish tissue waste and shrimp tissue waste (FIG. 10). Hydrochar samples produced from fish tissue waste contained several closely packed microspheres with cracks and holes. Likewise, hydrochar produced from shrimp tissue waste consisted of mostly plate-like flattened structures, with cracks and occasional spheres. The spheres in shrimp tissue waste hydrochar were not as densely packed as in fish tissue waste hydrochar. One characteristic feature that was noted about the shrimp tissue waste hydrochar was that it had several cracks, higher than what is observed in fish tissue waste hydrochar. Such cracks are likely to be formed during the release of volatile substances during MHTC. Such release of volatile substances has an effect on the quality of hydrochar produced. As previously described, extensive release of volatile substances results in hydrochar of lower densities, higher porosities, and significantly different pore structure. This suggests that the hydrochar produced could be used for producing diverse, densified carbon materials such as activated carbon, carbon fibers, and biocoal.

While the above description provides examples of one or more processes or apparatuses, it will be appreciated that other processes or apparatuses may be within the scope of the accompanying claims.

To the extent any amendments, characterizations, or other assertions previously made (in this or in any related patent applications or patents, including any parent, sibling, or child) with respect to any art, prior or otherwise, could be construed as a disclaimer of any subject matter supported by the present disclosure of this application, Applicant hereby rescinds and retracts such disclaimer. Applicant also respectfully submits that any prior art previously considered in any related patent applications or patents, including any parent, sibling, or child, may need to be re-visited.

### REFERENCES

Kaushik, R.; Parshetti, G. K.; Liu, Z.; Balasubramanian, R. Bioresour. Technol. 2014, 168, 267-274.
Afolabi, O. D.; Sohail, M.; Thomas, C. P. L. Waste Biomass Valorization 2015, 6, 147-157.
Chen, B.; Zhou, D.; Zhu, L. Environ. Sci. Technol. 2008, 42, 5137-5143.
Coates, J. Encyclopedia of Analytical Chemistry 2000, DOI: 10.1002/9780470027318.a5606.
Smidt, E.; Meissl, K. Waste Manage. 2007, 27, 268-276.
Allison, G. G.; Morris, C.; Hodgson, E.; Jones, J.; Kubacki, M.; Barraclough, T.; Yates, N.; Shield, I.; Bridgwater, A. V.; Donnison, I. S. Bioresour. Technol. 2009, 100, 6428-6433.
Pavia, D.; Lampman, G.; Kriz, G.; Vyvyan, J. Introduction to Spectroscopy; Cengage Learning: Belmont, Calif., 2008.
Soldi, R. A.; Oliveira, A. R. S.; Ramos, L. P.; Cesar-Oliveira, M. A. F. Appl. Catal., A 2009, 361, 42-48.
El Ichi, S.; Zebda, A.; Laaroussi, A.; Reverdy-Bruas, N.; Chaussy, D.; Belgacem, M. N.; Cinquin, P.; Martin, D. K. Chem. Commun. 2014, 50, 14535-14538.

1. A method for processing non-lignocellulosic waste, comprising:
a) pre-treating the non-lignocellulosic waste by enzymatic hydrolysis to yield a pre-treated non-lignocellulosic waste; and
b) subjecting the pre-treated non-lignocellulosic waste to microwave hydrothermal carbonization to yield at least one of a hydrochar and a biocrude liquor.

2. The method of claim 1, wherein the non-lignocellulosic waste is not combined with any lignocellulosic waste in steps a) and b).

3. The method of claim 1, wherein the non-lignocellulosic waste comprises animal tissue.

4. The method of claim 1, wherein the non-lignocellulosic waste comprises aquatic animal tissue.

5. The method of claim 1, wherein the non-lignocellulosic waste comprises at least one of fish tissue and shellfish tissue.

6. The method of claim 1, further comprising:
c) separating the hydrochar from the biocrude liquor; and
d) drying the hydrochar.

7. The method of claim 1, wherein step b) comprises subjecting the pre-treated non-lignocellulosic waste to microwave hydrothermal carbonization at a temperature of between 120 degrees Celsius and 250 degrees Celsius.

8. The method of claim 1, wherein step b) comprises subjecting the pre-treated non-lignocellulosic waste to microwave hydrothermal carbonization at a temperature of between 150 degrees Celsius and 210 degrees Celsius.

9. The method of claim 1, wherein step b) comprises subjecting the pre-treated non-lignocellulosic waste to microwave hydrothermal carbonization at a temperature of between about 150 degrees Celsius and about 180 degrees Celsius.

10. The method of claim 1, wherein step b) comprises subjecting the pre-treated non-lignocellulosic waste to microwave hydrothermal carbonization for a time of between 45 minutes and 180 minutes.

11. The method of claim 1, wherein step b) comprises subjecting the pre-treated non-lignocellulosic waste to microwave hydrothermal carbonization for a time of between 60 minutes and 120 minutes.

12. The method of claim 1, wherein step b) comprises subjecting the pre-treated non-lignocellulosic waste to microwave hydrothermal carbonization for a time of about 60 minutes.

13. The method of claim 1, further comprising, prior to step a), at least one of homogenizing and cooking the non-lignocellulosic waste.

14. The method of claim 1, wherein step a) comprises: pre-treating the non-lignocellulosic waste with at least one of a lipase enzyme, a protease enzyme, and a carbohydrase enzyme.

15. The method of claim 14, wherein the carbohydrase enzyme comprises at least one of an amylase anyzme, an arabanase enzyme, a beta-glucanase enzyme, and a xylanase enzyme.

16. The method of claim 1, wherein in step a), the enzyme concentration is between 2.5 wt % and 50 wt %.

17. The method of claim 1, wherein in step a), the enzyme concentration is between 10 wt % and 20 wt %.

18. The method of claim 1, wherein step a) comprises pre-treating the non-lignocellulosic waste by enzymatic hydrolysis for a period of between 1 hour and 60 hours.

19. The method of claim 1, wherein step a) comprises pre-treating the non-lignocellulosic waste by enzymatic hydrolysis for a period of between 4 hours and 24 hours.

20. The method of claim 1, wherein step a) comprises pre-treating the non-lignocellulosic waste by enzymatic hydrolysis for a period of about 16 hours.

21. The method of claim 1, further comprising using the hydrochar as at least one of a fuel, a fertilizer, and a carbon sequestering agent.

22. A system for processing non-lignocellulosic waste, comprising:
a) an enzymatic hydrolysis station for receiving non-lignocellulosic waste and generating a treated non-lignocellulosic waste; and
b) a microwave hydrothermal carbonization station downstream of the enzymatic hydrolysis station for receiving the treated non-lignocellulosic waste from the enzymatic hydrolysis station and generating at least one of a hydrochar and a biocrude liquor.

23. The system of claim 22, further comprising a preparation station upstream of the enzymatic hydrolysis station for at least one of homogenizing and cooking the non-lignocellulosic waste.

24. The system of claim 22, further comprising a post-treatment station downstream of the microwave hydrothermal carbonization station for separating the hydrochar and the biocrude liquor.
